(19) United States
(12) Patent Application Publication
(10) Pub. No.: US 2021/0162779 A1
(43) Pub. Date: Jun. 3, 2021

(54) VARIABLE RADIUS PULLEYS

(71) Applicant: Hewlett-Packard Development Company, L.P., Spring, TX (US)

(72) Inventors: Robert Yraceburu, Vancouver, WA (US); Gene Jones, Vancouver, WA (US)

(21) Appl. No.: 16/645,049

(22) PCT Filed: Sep. 15, 2017
(86) PCT No.: PCT/US2017/051906

§ 371 Date: Mar. 6, 2020

(51) Int. Cl. B41J 11/00; B65H 29/12; B65H 29/70

(52) U.S. Cl. CPC B41J 11/0005; B65H 29/70; B65H 29/12

(57) ABSTRACT

A number of systems and devices for a variable radius pulley are described herein. In one example, a media puller device can include a variable radius pulley coupled to a drag roller, and a cable coupled to the variable radius pulley to maintain a torque on the drag roller as the cable wraps around the variable radius pulley.

### BACKGROUND

Inkjet printers can deposit quantities of printing fluid onto a printable media (e.g., paper, plastic, etc.). In some examples, inkjet printers can create a curl and/or cockle in the printed media when the printing fluid droplets are deposited by the inkjet printer. In some examples, a number of physical properties of the printable media can be changed when the printing fluid droplets are deposited by the inkjet printer. For example, the stiffness of the printable media can be changed when the printing fluid droplets are deposited by the inkjet printer. The curl, cockle, and/or other physical properties that change due to the printing fluid droplets can make document finishing processes difficult.

### BRIEF DESCRIPTION OF THE DRAWINGS

FIG. 1 illustrates an example variable radius pulley consistent with the present disclosure.

FIG. 2 illustrates an example variable radius pulley consistent with the present disclosure.

FIG. 3 illustrates an example variable radius pulley consistent with the present disclosure.

FIG. 4 illustrates an example variable radius pulley consistent with the present disclosure.

### DETAILED DESCRIPTION

A number of systems and devices for a variable radius pulley are described herein. In one example, a media puller device can include a variable radius pulley coupled to a drag roller, and a cable coupled to the variable radius pulley to maintain a torque on the drag roller as the cable wraps around the variable radius pulley. In some examples, a system for a variable radius pulley can include a variable radius pulley that includes a spiral section, a drag roller coupled to the variable radius pulley to receive print media, a cable coupled to the variable radius pulley to wrap around the spiral section, and a spring coupled to the cable to apply a resistive force when the cable wraps around the spiral section.

In some examples, a finishing device described herein can include a media puller that includes a first drag roller and a second drag roller to clamp received print media, a variable radius pulley coupled to the first drag roller, wherein the variable radius pulley includes a spiral section that alters a radius of the variable radius pulley as the variable radius pulley rotates, a cable coupled to the variable radius pulley to wrap around the spiral section when the received print media is released from the first drag roller and the second drag roller, and a spring coupled to the cable to apply a resistive force when the cable wraps around the spiral section.

The systems and devices described herein can include a drag roller that applies a consistent force on the print media when the print media is removed from the media puller. The consistent force can prevent distorting properties of the print media when the print media is partially dried inkjet media. Previous systems and devices can include a drag roller that applies increasing force as the media is removed from the media puller. In some examples, the force applied to the print media can correspond to a distance the print media travels across the drag roller. The present disclosure includes a variable radius pulley coupled to the drag puller so that the drag puller applies consistent force on the print media despite the distance the print media travels across the drag roller.

In some examples, the systems and devices for a variable radius puller can be utilized by a finisher of an inkjet printing device that generates partially dried inkjet media. The inkjet printing device can include a print zone to deposit a printing fluid on a print media. The print zone of the inkjet printing device can deposit the printing fluid to generate partially dried inkjet media. In some examples, the partially dried inkjet media can provide difficulties when stacking, aligning, and/or finishing.

For example, the partially dried inkjet media can have distorted properties such as a curl, a cockle, a reduction in stiffness, increased surface roughness, extruding or protruding fibers from the surface, misaligned fibers, and/or increased sheet to sheet friction of the media. In some examples, these distorted properties can be caused by printing fluid deposited on the media and the media absorbing the printing fluid. For example, the printing fluid can be in a liquid state that can be absorbed by a media such as paper. In this example, the liquid state of the printing fluid can cause the distorted properties of the media in a similar way that other liquids may distort the properties of the media.

The systems and devices for a variable radius pulley described herein can be utilized by a media puller of a finisher of an inkjet printing device. In some examples, the media puller can be utilized to stack the partially dried inkjet media of an inkjet printing device. As described herein, the variable radius puller can be coupled to a drag roller to maintain a force provided by the drag roller on the partially dried inkjet media as the partially dried inkjet media travels across the drag roller. In this way, additional property distortions from the drag roller can be prevented by maintaining a force applied to the partially dried inkjet media.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

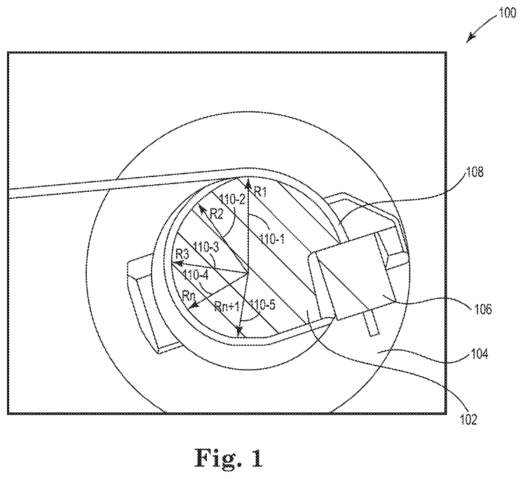

FIG. 1 illustrates an example variable radius pulley 102 consistent with the present disclosure. In some examples, FIG. 1 can illustrate a system 100 that includes a variable radius pulley 102 coupled to a drag roller 104. In some examples, the variable radius pulley 102 can be utilized to provide resistance and/or force on print media clamped by the system 100. For example, the variable radius pulley 102 can be coupled to a side of the drag roller 104 such that rotation of the variable radius pulley 102 also rotates the drag roller 104.

In some examples, the variable radius pulley 102 can include a spiral section. In some examples, the spiral section decreases a radius of the variable radius pulley 102 as the cable 108 wraps around the variable radius pulley 102. In some examples, the spiral section can include a plurality of different radii 110-1, 110-2, 110-3, 110-4, 110-5 to maintain a torque applied to the drag roller 104. In some examples, the radius of the variable radius pulley 102 can alter for each angle of rotation by the variable radius pulley 102. For example, a first angle of rotation can occur between radius 110-1 and radius 110-2. In this example, the radius of the variable radius pulley 102 can decrease during the first angle of rotation. That is, the radius 110-1 can be greater than the radius 110-2. In another example, a second angle of rotation can occur between radius 110-2 and radius 110-3. In this example, the radius can decrease during the angle of rotation between radius 110-2 and radius 110-3. In this example, the radius 110-2 can be greater than the radius 110-3. As used herein, an angle of rotation is a measurement of an amount of angular rotation.

In some examples, the variable radius pulley 102 can be coupled to a cable 108 via a cable connector 106. The cable connector 106 can permanently or semi-permanently couple the cable 108 to a particular position of the variable radius pulley 102. For example, the cable connector 106 can couple the cable 108 to a position that wraps a portion of the cable around the variable radius pulley 102. In this example, the cable connector 106 can couple the cable 108 such that the cable 108 is in contact with the variable radius pulley 102 from the cable connector 106 to a first radius 110-1 of the variable radius pulley 102. In this example, a torque on the drag roller 104 can be affected by the first radius 110-1 of the variable radius pulley 102. In some examples, the spiral section decreases a radius at a cable/pulley surface contact point (e.g., cable contact point, etc.) of the variable radius pulley 102 as the cable 108 wraps around the variable radius pulley 102. As used herein, the cable/pulley surface contact point or cable contact point is a point where the cable 108 stops contacting the variable radius pulley 102. For example, the cable/pulley surface contact point can be at the first radius 110-1 of the variable radius pulley 102.

In some examples, the cable 108 can be connected to a spring or other type of resistance device to provide a resistive force or spring force on the variable radius pulley 102. In some examples, the system 100 can include a print media puller that can pinch a piece of print media utilizing the drag roller 104. In some examples, the print media can be released when the print media interacts with a registration surface. In these examples, the media can rotate the drag roller 104 and variable radius pulley 102 in a clockwise direction as illustrated in FIG. 1.

In some examples, the variable radius pulley 102 can include a spiral section to alter a radius of the variable radius pulley 102. For example, the variable radius pulley 102 can include a plurality of different radii 110-1, 110-2, 110-3, 110-4, 110-5 to lower a radius of the variable radius pulley 102 as the print media rotates the drag roller 104 in the clockwise direction. For example, the variable radius pulley 102 can rotate in a clockwise direction and wrap the cable 108 around a cylinder of the variable radius pulley 102. In this example, the radius of the cylinder can decrease from the first radius 110-1 to an n+1 radius 110-5. In some examples, the first radius 110-1 can be a first distance that is greater than a second radius 110-2, the second radius 110-2 can be a distance that is greater than a third radius 110-3, the third radius 110-3 can be a distance that is greater than a fourth radius 110-4, and the fourth radius 110-4 can be a distance that is greater than an n+1 radius 110-5.

As described herein, the cable 108 can be coupled to a spring or other type of resistance device. In some examples, the spring coupled to the cable 108 can increase a force applied to the cable 108 as the cable wraps around the variable radius pulley 102. For example, as the spring stretches when the cable 108 wraps around the variable radius pulley 102, the force the spring applies to the cable 108 can be increased. In some examples, the variable radius pulley 102 can counter the increased force of the spring by decreasing the radius to provide a consistent torque applied to the drag roller that applies a constant force to the print media.

In some examples, a torque applied to the drag roller 104 can be maintained despite an angle of rotation from the variable radius pulley 102. For example, the torque for each angle of rotation can be calculated utilizing Equation 1. Equation 1 can include a torque (T) that can be calculated by multiplying the spring force (Fspring) and a corresponding pulley radius (Rpulley) of the variable radius pulley 102. For example, the Rpulley 1 can be the radius 110-1 of the variable raidus pulley 102 and the Fspring 1 can be the corresponding spring force of a spring coupled to the cable 108. In this example, the torque (T) of the radius 110-1 and the corresponding spring force can be equal to the torque (T) of the raidius 110-2 (Rpulley 2) and a corresponding spring force (Fspring 2).

T=Fspring 1×Rpulley1=Fspring 2×Rpulley 2 =Fspring N×Rpulley N Equation 1

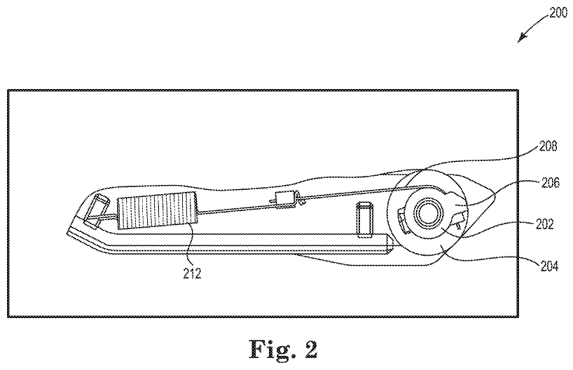

FIG. 2 illustrates an example variable radius pulley 202 consistent with the present disclosure. In some examples, the system 200 can be a portion of a media puller of a finisher coupled to an inkjet printing device. For example, the system 200 can be a portion of a media puller that can receive partially dried inkjet media from a print zone of the inkjet printing device and transport the partially dried inkjet media from a first side of the finisher to a second side of the finisher for stacking the partially dried inkjet media. In some examples, the partially dried inkjet media can be distorted if a torque on a drag roller exceeds a torque threshold. In some examples, the system 200 can utilize a variable radius pulley 202 to maintain a torque below a torque threshold for the partially dried inkjet media.

In some examples, the system 200 for a variable radius pulley 202 can include a variable radius pulley 202 that includes a spiral section, a drag roller 204 coupled to the variable radius pulley 202 to receive print media, a cable 208 coupled to the variable radius pulley 202 to wrap around the spiral section, and a spring 212 coupled to the cable 208 to apply a resistive force when the cable 208 wraps around the spiral section. As described herein, the spiral section can be a cylinder of the variable radius pulley that includes a plurality of radii for altering a torque on the drag roller 204. In some examples, the radius of the variable radius pulley 202 can decrease as the cable 208 wraps around the spiral section of the variable radius pulley 202. In some examples, the radius of the spiral section can be altered during a rotation when the cable 208 wraps around the spiral section. In some examples, the rotation can be a single rotation.

In some examples, the variable radius pulley 202 can be coupled to a cable 208 via a cable connector 206. The cable connector 206 can permanently or semi-permanently couple the cable 208 to a particular position of the variable radius pulley 202. For example, the cable connector 206 can couple the cable 208 to a position that wraps a portion of the cable around the variable radius pulley 202. In this example, the cable connector 206 can couple the cable 208 such that the cable 108 is in contact with the variable radius pulley 202 from the cable connector 106 to a particular radius of the variable radius pulley 202.

In some examples, the spring 212 can include a spring constant. In some examples, the spring constant can be between 1 gram per millimeter and 5 grams per millimeter. In a specific example, the spring constant for the spring 212 can be 3 grams per millimeter. In some examples, the spring 212 can include a spring force. For example, the spring 212 can include a spring force between 20 grams and 40 grams. In a specific example, the spring 212 can include a spring force of 31 grams. In some examples, the spring 212 can be stretched when print media is removed from the system 200 and passes across the drag roller 204. In some examples, the spring force of the spring 212 can increase when the spring is stretched, when the cable 208 wraps around the variable radius pulley 202, and/or when the drag roller 204 is moving in a clockwise direction as illustrated in FIG. 2.

In some examples, the spiral section decreases a radius at a cable/pulley surface contact point (e.g., cable contact point, etc.) of the variable radius pulley 202 as the cable 208 wraps around the variable radius pulley 202. As used herein, the cable/pulley surface contact point or cable contact point is a point where the cable 208 stops contacting the variable radius pulley 202. For example, the cable/pulley surface contact point can be at a particular radius of the variable radius pulley 202.

As described herein, the drag roller 204 can have a constant torque level when releasing the print media. The torque on the drag roller 204 can be calculated utilizing a radius of the variable radius pulley 202 and a spring force of the spring 212. For example, the torque on the drag roller 204 can be calculated by multiplying the spring force of the spring 212 and a radius of the variable radius pulley 202. In this example, the radius of variable radius pulley 202 can decrease as the spring force of the spring 212 increases. In this way, the calculated torque on the drag roller 204 can stay constant as the drag roller 204 rotates clockwise when releasing the partially dried inkjet media as described herein.

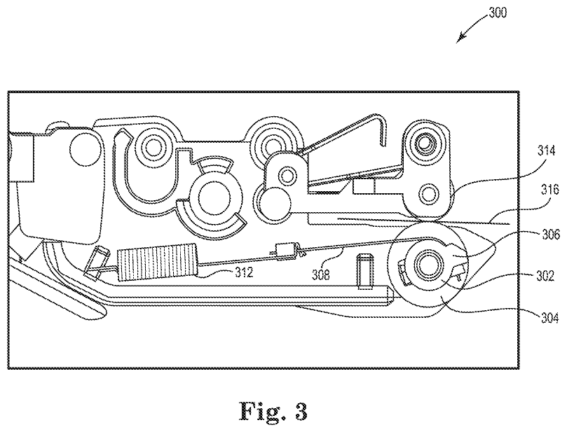

FIG. 3 illustrates an example variable radius pulley 302 consistent with the present disclosure. In some examples, the system 300 can be a portion of a media puller of a finisher coupled to an inkjet printing device. For example, the system 300 can be a portion of a media puller that can receive partially dried inkjet media 316 from a print zone of the inkjet printing device and transport the partially dried inkjet media 316 from a first side of the finisher to a second side of the finisher for stacking the partially dried inkjet media 316. In some examples, the partially dried inkjet media 316 can be distorted if a torque on a drag roller 304 exceeds a torque threshold. In some examples, the system 300 can utilize a variable radius pulley 302 to maintain a torque on the drag roller 304 so a force is below a force threshold for the partially dried inkjet media 316.

In some examples, a finishing device described herein can include a media puller that includes a first drag roller 304 and a second drag roller 314 to clamp received print media 316, a variable radius pulley 302 coupled to the first drag roller 304, wherein the variable radius pulley 302 includes a spiral section that alters a radius of the variable radius pulley 302 as the variable radius pulley 302 rotates, a cable 308 coupled to the variable radius pulley 302 to wrap around the spiral section when the received print media 316 is released from the first drag roller 304 and the second drag roller 314, and a spring 312 coupled to the cable 308 to apply a resistive force when the cable 308 wraps around the spiral section.

In some examples, the variable radius pulley 302 can be coupled to a cable 308 via a cable connector 306. The cable connector 306 can permanently or semi-permanently couple the cable 308 to a particular position of the variable radius pulley 302. For example, the cable connector 306 can couple the cable 308 to a position that wraps a portion of the cable around the variable radius pulley 302. In this example, the cable connector 306 can couple the cable 308 such that the cable 308 is in contact with the variable radius pulley 302 from the cable connector 306 to a particular radius of the variable radius pulley 302. As described herein, the particular radius can be altered as the variable radius pulley 302 rotates in a clockwise direction as illustrated in FIG. 3.

In some examples, the spring 312 can include a spring constant. In some examples, the spring constant can be between 1 gram per millimeter and 5 grams per millimeter. In a specific example, the spring constant for the spring 312 can be 3 grams per millimeter. In some examples, the spring 312 can include a spring force. For example, the spring 312 can include a spring force between 20 grams and 40 grams. In a specific example, the spring 312 can include a spring force of 31 grams. In some examples, the spring 312 can be stretched when print media 316 is removed from between the first drag roller 304 and the second drag roller 314. As described herein, the print media 316 can rotate the first drag roller 304 in a clockwise direction and rotate the second drag roller 314 in a counter clockwise direction as illustrated in FIG. 3. In some examples, the spring force of the spring 312 can increase when the spring is stretched, when the cable 308 wraps around the variable radius pulley 302, and/or when the drag roller 304 is moving in a clockwise direction as illustrated in FIG. 3.

The torque on the drag roller 304 can be calculated utilizing a radius of the variable radius pulley 302 and a spring force of the spring 312. For example, the torque on the drag roller 304 can be calculated by multiplying the spring force of the spring 312 and a radius of the variable radius pulley 302. In this example, the radius of variable radius pulley 302 can decrease as the spring force of the spring 312 increases. In this way, the calculated torque on the drag roller 304 can stay constant as the drag roller 304 rotates clockwise when releasing the partially dried inkjet media as described herein.

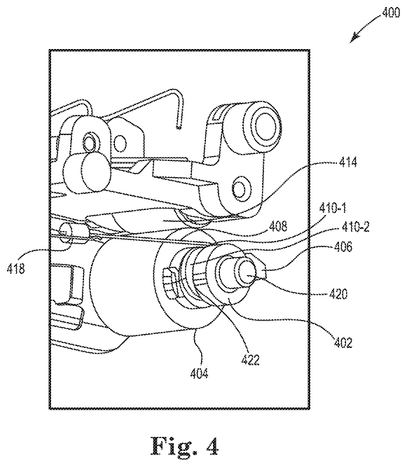

FIG. 4 illustrates an example variable radius pulley 402 consistent with the present disclosure. In some examples, the system 400 can be a portion of a media puller of a finisher coupled to an inkjet printing device. For example, the system 400 can be a portion of a media puller that can receive partially dried inkjet media from a print zone of the inkjet printing device and transport the partially dried inkjet media from a first side of the finisher to a second side of the finisher for stacking the partially dried inkjet media. In some examples, the partially dried inkjet media can be distorted if a torque of a drag roller 404 exceeds a torque threshold. In some examples, the system 400 can utilize a variable radius pulley 402 to maintain a torque below a torque threshold for the partially dried inkjet media.

In some examples, the variable radius pulley 402 can be coupled to the drag roller 404 via a shaft 420. The shaft 420 can be positioned through a center portion of the variable radius pulley 402 and through a center portion of the drag roller 404 to synchronize the rotation of the variable radius pulley 402 and the drag roller 404. For example, rotation of the drag roller 404 can rotate the variable radius pulley 402 a same rotational distance when the drag roller 404 and variable radius pulley 402 are coupled by the shaft 420.

In some examples, the variable radius pulley 402 can be coupled to a cable 408 via a cable connector 406. The cable connector 406 can permanently or semi-permanently couple the cable 408 to a particular position of the variable radius pulley 402. For example, the cable connector 406 can couple the cable 408 to a position that wraps a portion of the cable around the variable radius pulley 402. In this example, the cable connector 406 can couple the cable 408 such that the cable 408 is in contact with the variable radius pulley 402 from the cable connector 406 to a particular radius of the variable radius pulley 402. As described herein, the particular radius can be altered as the variable radius pulley 402 rotates in a clockwise direction as illustrated in FIG. 4.

In some examples, a finishing device described herein can include a media puller that includes a first drag roller 404 and a second drag roller 414 to clamp received print media, a variable radius pulley 402 coupled to the first drag roller 404, wherein the variable radius pulley 402 includes a spiral section 422 that alters a radius 410-1, 410-2 of the variable radius pulley 402 as the variable radius pulley 402 rotates, a cable 408 coupled to the variable radius pulley 402 to wrap around the spiral section 422 when the received print media is released from the first drag roller 404 and the second drag roller 414, and a spring coupled to the cable 408 to apply a resistive force when the cable 408 wraps around the spiral section 422.

The torque on the drag roller 404 can be calculated utilizing a radius of the drag roller 404 and a spring force of the spring. For example, the torque on the drag roller 404 can be calculated by multiplying the spring force of the spring and a radius of the variable radius pulley 402. In this example, the radius of variable radius pulley 402 can decrease as the spring force of the spring increases. In this way, the calculated torque on the drag roller 404 can stay constant as the drag roller 404 rotates clockwise when releasing the partially dried inkjet media as described herein.

In some examples, the torque on the drag roller 404 can be a constant torque despite a rotational distance of the variable radius pulley 402 and/or a stretch distance of the spring. As described herein, the radius of the variable radius pulley 402 can be a position where the cable 408 contacts the variable radius pulley 402. For example, FIG. 4 illustrates when the cable 408 is positioned at radius 410-1. In this example, the cable 408 can wrap around the variable radius pulley 402 and contact the variable radius pulley 402 at radius 410-2. In some examples, the radius 410-1 can be a greater distance than radius 410-2. As described herein, a spring coupled to the cable 408 can be stretched when the cable 408 wraps around the variable radius pulley 402. In some examples, when the spring is stretched a resistance or spring force provided by the spring can increase. In these examples, the radius of the variable radius pulley 402 can decrease to maintain a constant torque despite the stretch distance of the spring and/or the rotational distance of the variable radius pulley 402.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A media puller device, comprising:
a variable radius pulley coupled to a drag roller; and
a cable coupled to the variable radius pulley to maintain a torque on the drag roller as the cable wraps around the variable radius pulley.

2. The lamination device of claim 1, wherein the variable radius pulley includes a spiral section to alter a radius of the variable radius pulley.

3. The lamination device of claim 2, wherein the spiral section decreases a radius at a cable/pulley surface contact point of the variable radius pulley as the cable wraps around the variable radius pulley.

4. The lamination device of claim 1, comprising a spring coupled to the cable to apply a resistive force.

5. The lamination device of claim 4, wherein the resistive force of the spring increases as the cable wraps around the variable radius pulley.

6. A system, comprising:
a variable radius pulley that includes a spiral section;
a drag roller coupled to the variable radius pulley to receive print media;
a cable coupled to the variable radius pulley to wrap around the spiral section; and
a spring coupled to the cable to apply a resistive force when the cable wraps around the spiral section.

7. The system of claim 6, wherein the drag roller maintains a constant torque level when releasing the print media.

8. The system of claim 6, wherein a radius of a cable contact point of the spiral section decreases as the cable wraps around the spiral section.

9. The system of claim 8, wherein the resistive force of the spring increases as the cable wraps around the spiral section.

10. The system of claim 6, wherein the radius of the spiral section is altered during a rotation when the cable wraps around the spiral section.

11. The system of claim 10, wherein the rotation is a single rotation.

12. A finishing device, comprising:
a media puller that includes a first drag roller and a second drag roller to clamp received print media;
a variable radius pulley coupled to the first drag roller, wherein the variable radius pulley includes a spiral section that alters a radius of the variable radius pulley as the variable radius pulley rotates;
a cable coupled to the variable radius pulley to wrap around the spiral section when the received print media is released from the first drag roller and the second drag roller; and
a spring coupled to the cable to apply a resistive force when the cable wraps around the spiral section.

13. The finishing device of claim 12, wherein the radius of the variable radius pulley alters for each angle of rotation by the variable radius pulley.

14. The finishing device of claim 13, wherein the radius of the variable radius pulley decreases for each angle of rotation when the variable radius pulley rotates in a clockwise direction.

15. The finishing device of claim 12, wherein a force applied by the first drag roller to the received print media is maintained despite an angle of rotation from the variable radius pulley.
